(19) United States
(12) Patent Application Publication
(10) Pub. No.: US 2012/0077015 A1
(43) Pub. Date: Mar. 29, 2012

(54) Multi-Layer Nano-Composites

(76) Inventors: Hao Zhou, Boiling Springs, SC (US); Walter A. Scrivens, Moore, SC (US)

(21) Appl. No.: 12/893,030

(22) Filed: Sep. 29, 2010

(51) Int. Cl. B32B 5/26; B32B 27/04; B29C 47/06; B32B 27/02

(52) U.S. Cl. 428/300.4; 428/301.4; 264/171.1; 977/961

(57) ABSTRACT

A nano-composite article containing a nanofiber layer and a supporting layer. The nanofiber layer has a first outer boundary adjacent the supporting layer, a second outer boundary on the side of the nanofiber layer opposite the supporting layer and an inner boundary located at the mid-point between the first outer boundary and the second outer boundary and parallel to the first outer boundary. The nanofiber layer contains a matrix and a plurality of nanofibers, where at least 70% of the nanofibers are bonded to other nanofibers. The supporting layer contains a thermoplastic polymer. The concentration of nanofibers is substantially uniform in the nanofiber layer from the inner boundary to the first boundary layer.

### RELATED APPLICATIONS

This application is related to the following applications, each of which is incorporated by reference: Attorney docket number 6275 entitled “Process of Forming Nano-Composite and Nano-Porous Non-Wovens”, attorney docket number 6475 entitled “Core/Shell Nanofiber Non-Woven”, attorney docket number 6483 entitled “Gradient Nanofiber Non-Woven”, attorney docket number 6406 entitled “Nanofiber Non-Wovens Containing Particles”, attorney docket number 6476 entitled “Process of Forming a Nanofiber Non-woven Containing Particles”, and attorney docket number 6477 entitled “Nanofiber Non-Woven Composite”, each of which being filed on Sep. 29, 2010.

### TECHNICAL FIELD

The present application is directed to processes for forming multi-layer nano-composites and nano-porous non-wovens and the related processes.

### BACKGROUND

Nanofibers have a high surface area to volume ratio which alters the mechanical, thermal, and catalytic properties of materials. Nanofiber added to composites may either expand or add novel performance attributes to existing applications such as reduction in weight, breathability, moisture wicking, increased absorbency, increased reaction rate, etc. The market applications for nanofibers are rapidly growing and promise to be diverse. Applications include filtration, barrier fabrics, insulation, absorbable pads and wipes, personal care, biomedical and pharmaceutical applications, whiteners (such as TiO₂ substitution) or enhanced web opacity, nucleators, reinforcing agents, acoustic substrates, apparel, energy storage, etc. Due to their limited mechanical properties that preclude the use of conventional web handing, loosely interlaced nanofibers are often applied to a supporting substrate such as a non-woven or fabric material and often an adhesive is applied to improve the adhesion between the nanofiber layer and the substrate. The bonding of the nanofiber cross over points may be able to increase the mechanical strength of the nanofiber non-wovens which potentially help with their mechanical handling and offer superior physical performance. It is also desirable to have a uniform distribution of nanofibers from the bulk of the material to the edges without any edge effects.

### BRIEF SUMMARY

The present disclosure provides a nano-composite article containing a nanofiber layer and a supporting layer which are co-extruded. The nanofiber layer has a first outer boundary adjacent the supporting layer, a second outer boundary on the side of the nanofiber layer opposite the supporting layer and an inner boundary located at the mid-point between the first outer boundary and the second outer boundary and parallel to the first outer boundary. The nanofiber layer contains a matrix and a plurality of nanofibers, where at least 70% of the nanofibers are bonded to other nanofibers. The supporting layer contains a thermoplastic polymer. The concentration of nanofibers is substantially uniform in the nanofiber layer from the inner boundary to the first boundary layer.

The present disclosure also provides for a nano-composite containing a nanofiber layer and a supporting layer. The nanofiber layer has a first outer boundary adjacent the supporting layer, a second outer boundary on the side of the nanofiber layer opposite the supporting layer and an inner boundary located at the mid-point between the first outer boundary and the second outer boundary and parallel to the first outer boundary. The nanofiber layer contains a non-woven formed from a plurality of nanofibers, where at least 70% of the nanofibers are bonded to other nanofibers. A supporting layer contains a thermoplastic polymer and the concentration of nanofibers is substantially uniform in the nanofiber layer from the inner boundary to the first boundary layer. The process of creating the nano-composites is also disclosed.

### BRIEF DESCRIPTION OF THE DRAWINGS

FIG. 1 illustrates a cross-section of one embodiment of the multi-layer nano-composite having one support layer.

FIG. 2 illustrates a cross-section of one embodiment of the non-woven nano-composite having one support layer.

FIG. 3 illustrates a cross-section of one embodiment of the nano-porous non-woven.

FIG. 4 illustrates a cross-section of one embodiment of the multi-layer nano-composite having two support layers.

FIG. 5 illustrates a cross-section of one embodiment of the non-woven nano-composite having two support layers.

FIG. 6 illustrates a cross-section of one embodiment of the nano-porous non-woven.

FIG. 7 illustrates a cross-section of one embodiment of the multi-layer nano-composite having two sub-layers in the nanofiber layer.

FIG. 8 illustrates a cross-section of one embodiment of the non-woven nano-composite having two sub-layers in the nanofiber layer.

FIG. 9 illustrates a cross-section of one embodiment of the nano-porous non-woven.

FIG. 10 illustrates a cross-section of one embodiment of the multi-layer nano-composite having one support layer, where the nanofiber layer contains nano-particles.

FIG. 11 illustrates a cross-section of one embodiment of the nano-porous non-woven, where the non-woven layer contains nano-particles.

FIG. 12 illustrates a cross-section of one embodiment of the multi-layer nano-composite having five layers total.

FIG. 13 illustrates a cross-section of one embodiment of the non-woven nano-composite.

FIGS. 14 and 15 are SEMs of Example 1.

FIGS. 16 and 17 are SEMs of Example 3.

### DETAILED DESCRIPTION

When immiscible polymer blends are processed in the molten state, the morphology of the minor phase morphology develops in a complex way. The minor phase may be subject to deformation, breakup, and/or coalescence when subjected to an external mechanical treatment. The morphology of the minor (discontinuous) phase is dependent on the viscosity ratio, the interfacial energy, the elasticity ratio of the components, and the processing conditions. The melted minor phase of the polymer blend elongates when subject to extensional forces. If the minor phase solidifies before the droplets break up, fibrillar morphology is obtained.

During melt extrusion, such as film extrusion, the outer boundary layer of the polymer melt experiences the strongest shear and shortest solidification time. Thus, finer fibrillar morphology of the minor phase is typically observed compared to the center region, resulting in a dense skin layer. Upon the removal process of the matrix (major phase), the dense skin layer can lead to a slow etching process even resulting in incomplete removal of the matrix in some instances where both sides of the film contain this dense “skin” layer. The nanofiber non-wovens obtained in this way tend to have dense skin layers on both sides which will result in slow flow rate when used in filtration applications.

In certain applications, such as liquid filtration, nanofiber media having gradient fiber distributions may be desirable, requiring one side of the media to contain denser nanofibers to enhance the filtration efficiency without compromising the flow rate. When the nanofiber distribution is fairly uniform, the pore size distribution of the non-woven is fairly narrow as well given that the fibers are randomly distributed.

“Nanofiber”, in this application, is defined to be a fiber having a diameter less than 1 micron. In certain instances, the diameter of the nanofiber is less than about 900, 800, 700, 600, 500, 400, 300, 200 or 100 nm, preferably from about 10 nm to about 200 nm. In certain instances, the nanofibers have a diameter from less than 100 nm. The nanofibers may have cross-sections with various regular and irregular shapes including, but not limiting to circular, oval, square, rectangular, triangular, diamond, trapezoidal and polygonal. The number of sides of the polygonal cross-section may vary from 3 to about 16.

“Non-woven” means that the layer or article does not have its fibers arranged in a predetermined fashion such as one set of fibers going over and under fibers of another set in an ordered arrangement.

As used herein, the term “thermoplastic” includes a material that is plastic or deformable, melts to a liquid when heated and freezes to a brittle, glassy state when cooled sufficiently. Thermoplastics are typically high molecular weight polymers. Examples of thermoplastic polymers that may be used include polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polymethylpentene (and co-polymers therof), polynorbornene (and co-polymers therof), polyethylene terephthalates, polyvinylidene fluorides, polysiloxanes, or the like, or a combination comprising at least one of the foregoing thermoplastic polymers. In some embodiments, polyolefins include polyethylene, poly(α-olefin)s. As used herein, poly(α-olefin) means a polymer made by polymerizing an alpha-olefin. An α-olefin is an alkene where the carbon-carbon double bond starts at the α-carbon atom. Exemplary poly(α-olefin)s include polypropylene, poly(l-butene) and polystyrene. Exemplary polyesters include condensation polymers of a C₂₋₁₂ dicarboxylic acid and a C₂₋₁₂ alkylenediol. Exemplary polyamides include condensation polymers of a C₂₋₁₂dicarboxylic acid and a C₂₋₁₂ alkylenediamine, as well as polycaprolactam (Nylon 6).

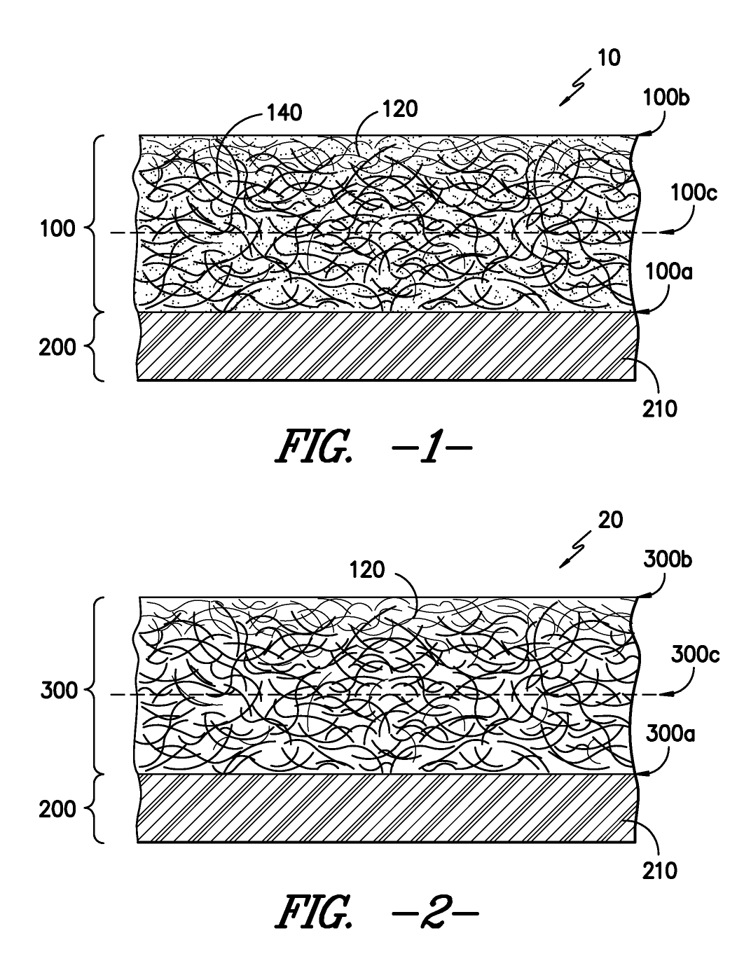

Referring to FIG. 1, there is shown one embodiment of a multi-layer nano-composite 10. The nanofiber layer 100 is located on a supporting layer 200. The nanofiber layer 100 and the supporting layer 200 are formed at the same time from molten or softened polymers, preferably by co-extrusion. In the nanofiber layer 100, the first outer boundary 100a is located at the surface of the nanofiber layer 100 adjacent the supporting layer 200. The second outer boundary 100b is located on surface of the nanofiber layer opposite the first outer boundary 100a. The inner boundary 100c is located at the mid-point plane between the first out boundary layer 100a and the second outer boundary layer 100b. The inner boundary 100c is not a physical boundary, but an imaginary plane in the bulk of the nanofiber layer 100. The nanofibers 120 within the nanofiber layer 100 have a substantially uniform fiber size and density from the inner boundary 100c to the first outer boundary 100a. Moving from the inner boundary 100c to the second outer boundary layer 100b the size of the nanofibers decreases and the density of the nanofibers increases.

The nanofiber layer 100 contains the first polymer 120 (also referred to as the nanofibers 120) and the second polymer 140 (also referred to as the matrix 140). Both the first polymer 120 and the second polymer 140 are thermoplastic polymers. The matrix (second polymer) 140 and the nanofibers (first polymer) 120 may be formed of any suitable thermoplastic polymer that is melt-processable. The second polymer preferably is able to be removed by a condition to which the first polymer is not susceptible. The most common case is the second polymer is soluble in a solvent in which the first polymer is insoluble. “Soluble” is defined as the state in which the intermolecular interactions between polymer chain segments and solvent molecules are energetically favorable and cause polymer coils to expand. “Insoluble” is defined as the state in which the polymer-polymer self-interactions are preferred and the polymer coils contract. Solubility is affected by temperature.

The solvent may be an organic solvent, water, an aqueous solution or a mixture thereof. Preferably, the solvent is an organic solvent. Examples of solvents include, but are not limited to, acetone, alcohol, chlorinated solvents, tetrahydrofuran, toluene, aromatics, dimethylsulfoxide, amides and mixtures thereof. Exemplary alcohol solvents include, but are not limited to, methanol, ethanol, isopropanol and the like. Exemplary chlorinated solvents include, but are not limited to, methylene chloride, chloroform, tetrachloroethylene, carbontetrachloride, dichloroethane and the like. Exemplary amide solvents include, but are not limited to, dimethylformamide, dimethylacetamide, N-methylpyrollidinone and the like. Exemplary aromatic solvents include, but are not limited to, benxene, toluene, xylene (isomers and mixtures thereof), chlorobenzene and the like. In another embodiment, the second polymer may be removed by another process such as decomposition. For example, polyethylene terephthalate (PET) may be removed with base (such as NaOH) via hydrolysis or transformed into an oligomer by reacting with ethylene glycol or other glycols via glycolysis, or nylon may be removed by treatment with acid. In yet another embodiment, the second polymer may be removed via depolymerization and subsequent evaporation/sublimation of smaller molecular weight materials. For example, polymethyleneoxide, after deprotection, can thermally depolymerize into formaldehyde which subsequently evaporates/sublimes away.

The first polymer 120 and the second polymer 140 are thermodynamically immiscible. Common miscibility predictors for non-polar polymers are differences in solubility parameters or Flory-Huggins interaction parameters. For polymers with non-specific interactions, such as polyolefins, the Flory-Huggins interaction parameter may be calculated by multiplying the square of the solubility parameter difference by the factor (V/RT), where V is the molar volume of the amorphous phase of the repeated unit V=M/Δ (molecular weight/density), R is the gas constant, and T is the absolute temperature. As a result, the Flory-Huggins interaction parameter between two non-polar polymers is always a positive number. Thermodynamic considerations require that for complete miscibility of two polymers in the melt, the Flory-Huggins interaction parameter has to be very small (e.g., less than 0.002 to produce a miscible blend starting from 100,000 weight-average molecular weight components at room temperature). It is difficult to find polymer blends with sufficiently low interaction parameters to meet the thermodynamic condition of miscibility over the entire range of compositions. However, industrial experience suggests that some blends with sufficiently low Flory-Huggins interaction parameters, although still not miscible based on thermodynamic considerations, form compatible blends.

Preferably the viscosity and surface energy of the first polymer 120 and the second polymer 140 are close. Theoretically, a 1:1 ratio would be preferred. If the surface energy and/or the viscosity are too dissimilar, nanofibers may not be able to form. In one embodiment, the second polymer 140 has a higher viscosity than the first polymer 120.

The first polymer 120 and second polymer 140 may be selected from any thermoplastic polymers that meet the conditions stated above, are melt-processable, and are suitable for use in the end product. Suitable polymers for either the first or second polymer include, but are not limited to polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polymethylpentene (and co-polymers therof), polynorbornene (and co-polymers therof), polyethylene terephthalates, polyvinylidene fluorides, polysiloxanes, or the like, or a combination comprising at least one of the foregoing thermoplastic polymers. In some embodiments, polyolefins include polyethylene, cyclic olefin copolymers (e.g. TOPAS®), poly(α-olefin)s. As used herein, poly(α-olefin) means a polymer made by polymerizing an alpha-olefin. An α-olefin is an alkene where the carbon-carbon double bond starts at the α-carbon atom. Exemplary poly(α-olefin)s include polypropylene, poly(l-butene) and polystyrene. Exemplary polyesters include condensation polymers of a C₂₋₁₂ dicarboxylic acid and a C₂₋₁₂ alkylenediol. Exemplary polyamides include condensation polymers of a C₂₋₁₂ dicarboxylic acid and a C₂₋₁₂ alkylenediamine. Additionally, the first and/or second polymers may be copolymers and blends of polyolefins, styrene copolymers and terpolymers, ionomers, ethyl vinyl acetate, polyvinylbutyrate, polyvinyl chloride, metallocene polyolefins, poly(alpha olefins), ethylene-propylene-diene terpolymers, fluorocarbon elastomers, other fluorine-containing polymers, polyester polymers and copolymers, polyamide polymers and copolymers, polyurethanes, polycarbonates, polyketones, and polyureas, as well as polycaprolactam (Nylon 6).

In one embodiment, some preferred polymers are those that exhibit an alpha transition temperature (T_{α}) and include, for example: high density polyethylene, linear low density polyethylene, ethylene alpha-olefin copolymers, polypropylene, poly(vinylidene fluoride), poly(vinyl fluoride), poly(ethylene chlorotrifluoroethylene), polyoxymethylene, poly(ethylene oxide), ethylene-vinyl alcohol copolymer, and blends thereof. Blends of one or more compatible polymers may also be used in practice of the invention. Particularly preferred polymers are polyolefins such as polypropylene and polyethylene that are readily available at low cost and may provide highly desirable properties in the microfibrous articles used in the present invention, such properties including high modulus and high tensile strength.

Useful polyamide polymers include, but are not limited to, synthetic linear polyamides, e.g., nylon-6, nylon-6,6, nylon-11, or nylon-12. Polyurethane polymers which may be used include aliphatic, cycloaliphatic, aromatic, and polycyclic polyurethanes. Also useful are polyacrylates and polymethacrylates, which include, for example, polymers of acrylic acid, methyl acrylate, ethyl acrylate, acrylamide, methylacrylic acid, methyl methacrylate, n-butyl acrylate, and ethyl acrylate, to name a few. Other useful substantially extrudable hydrocarbon polymers include polyesters, polycarbonates, polyketones, and polyureas. Useful fluorine-containing polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Representative examples of polyolefins useful in this invention are polyethylene, polypropylene, polybutylene, polymethylpentene (and co-polymers therof), polynorbornene (and co-polymers therof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene. Representative blends of polyolefins useful in this invention are blends containing polyethylene and polypropylene, low-density polyethylene and high-density polyethylene, and polyethylene and olefin copolymers containing the copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers.

The thermoplastic polymers may include blends of homo- and copolymers, as well as blends of two or more homo- or copolymers. Miscibility and compatibility of polymers are determined by both thermodynamic and kinetic considerations. A listing of suitable polymers may also be found in PCT published application WO2008/028134, which is incorporated in its entirety by reference.

The thermoplastic polymers may be used in the form of powders, pellets, granules, or any other melt-processible form. The particular thermoplastic polymer selected for use will depend upon the application or desired properties of the finished product. The thermoplastic polymer may be combined with conventional additives such as light stabilizers, fillers, staple fibers, anti-blocking agents and pigments. The two polymers are blended while both are in the molten state, meaning that the conditions are such (temperature, pressure) that the temperature is above the melting temperature (or softening temperature) of both of the polymers to ensure good mixing. This is typically done in an extruder. The polymers may be run through the extruder more than once to ensure good mixing to create the discontinuous regions which then form the nanofibers.

In one embodiment, the first polymer content of the first polymer/second polymer mixture is about 5% to about 90% by volume, preferably from 10% to about 70% vol, more preferably from 15% to about 60% vol, even more preferably from about 17% to about 50% vol. In another embodiment, the first and second polymers have a volume ratio from about 100:1 to about 1:100, preferably, from about 40:1 to 1:40, more preferably from about 30:1 to about 1:30, even more preferably, from 20:1 to about 1:20; still even more preferably from 10:1 to 1:10; preferably from 3:2 to about 2:3. (4:1, 1:4) Preferably, the second polymer is the major phase comprising more than 50% by volume of the mixture.

Some preferred matrix (second polymer), nanofiber (first polymer), solvent combinations include, but are not limited to:

| | Nanofiber | Solvent |
|---|---|---|
| Matrix (second polymer) | (first polymer) | (for matrix) |
| Polymethyl methacrylate | Polypropylene (PP) | Toluene |
| (PMMA) | | |
| Cyclic olefin Copolymer | PP | Toluene |
| Cyclic Olefin copolymer | Thermoplastic | Toluene |
| | Elastomer (TPE) | |
| Cyclic Olefin Copolymer | Polyethylene (PE) | Toluene |
| Cyclic Olefin Copolymer | Polymethylpentene | Toluene |
| Polystyrene (PS) | Linear Low density | Toluene |
| | polyethylene | |
| | (LLDPE) | |
| Nylon 6 | PP | Formic Acid |
| Nylon 6 | PE | Formic Acid |
| PS | Polyethylene | Toluene |
| | terephthalate | |
| | (PET) | |
| PET | PP | decomposition |
| | | through hydrolysis |
| TPU (Thermoplastic | PP | Dimethyl |
| Polyurethane) | | formamide (DMF) |
| TPU | PE | DMF |
| TPU | Nylon | DMF |
| poly(vinyl alcohol) (PVA) | PP | Water |
| Cyclic olefin | TPU | Toluene |
| PS | TPU | Toluene |
| Polycarbonate (PC) | Nylon | Toluene |
| PC | PP | Toluene |
| Polyvinyl chloride (PVC) | PP | Chloroform |
| Noryl (Polyphenyleneoxide | PP | Toluene |
| PPO and PS blend) | | |
| Noryl | Nylon 6 | Chloroform |
| Polyacrylonitrilebutadiene- | Nylon 6 | Hexane |
| styrene (ABS) | | |
| ABS | PP | Chloroform |
| PVC | Nylon | Benzene |
| Polybutyleneterephthalate | PE | trifluoroacetic acid |
| (PBT) | | |

In one embodiment, the second polymer is polystyrene and the first polymer could be linear low density polyethylene (LLDPE), high density polyethylene (HDPE), isotactic polypropylene (iPP), polyethylene terephthalate (PET), polytrimethylene terephthalate (PTT), polybutylene terephthalate (PBT), poly(butylene adipate terephthalate) (PBAT), poly(Ethylene terephthalate-co-isophthalate)-poly(ethylene glycol) (IPET-PEG), and a highly modified cationic ion-dyeable polyester (HCDP).

In another embodiment, a third polymer may be added. This third polymer is a thermoplastic polymer that may be form additional nanofibers or additional matrix. The third polymer may be soluble or insoluble in the solvent that the second polymer is soluble in, depending on the desired end product. In one embodiment, the first and third polymers are insoluble in a solvent that the second polymer is soluble in. The amounts of polymers are selected such that the first and third polymers form nanofibers in a matrix of the second polymer. This second polymer may be partially or fully removed by the solvent. In another embodiment, the first polymer is insoluble in a solvent that the second polymer and the third polymer are soluble in. The amounts of polymers are selected such that the first polymer forms nanofibers in a matrix of the second polymer and the third polymer. The second and third polymers may be partially or fully removed by the solvent. In another embodiment, the second polymer is soluble in a first solvent, the third polymer is soluble in a second solvent, and the first polymer is insoluble in the first and second solvents. The amounts of polymers are selected such that the first polymer forms nanofibers in a matrix of the second polymer and the third polymer. This second and third polymer may be selectively removed by the first and/or second solvent.

In another embodiment, a third component, reactive or non-reactive, such as a compatiblizer, a blooming agent, or a co-polymer may be add in the system so at least part of it migrates to the interface between the first and second polymer in the first intermediate. Such a third component may be selected to be partially soluble or insoluble in the second solvent. This third component will be exposed on the surface of the first polymer after etching. Via further chemistry, the third component surface of the first polymer may have added functionality (reactivity, catalytically functional, conductivity, chemical selectivity) or modified surface energy for certain applications. For example, in a PS/PP system (second polymer/first polymer), PP-g-MAH (maleated PP) or PP-g-PS, styrene/ethylene-butylene/styrene (SEBS) may be added to the system. The added MAH and the styrene functional groups may be further reacted to add functionality to the nano-composite or nano-porous non-woven.

In another embodiment, the third component may be any suitable material the blooms or moves to the surface of the first polymer when subjected to heat and extensional forces. In some embodiments, the third component may be a polymer, co-polymer, a large molecule, or a small molecule. Typically, the third component has a smaller molecular weight than the bulk polymer. In one embodiment, the third component has one-tenth the molecular weight of the bulk polymer. In another embodiment, the third component has one-thousandth the molecular weight of the bulk polymer. In another embodiment, the third component has one-millionth the molecular weight of the bulk polymer. As a general rule, the greater the difference between the molecular weights of the bulk polymer and third component, the greater the amount of bloom (which results in more of the third component at the surface of the nanofiber). In one embodiment, the third component is a lubricant. The third component being a lubricant would help control the release properties of the nanofibers and non-woven. The third component being a lubricant also allows the nanofibers to more easily move across each other during consolidation giving better randomization. A lubricant could also alter the mechanical properties of the final non-woven structure.

Referring back to FIG. 1, there is also shown the supporting layer 200 comprising the supporting polymer 210. The nanofiber layer 100 and supporting layer 200 are formed together, preferably through co-extrusion. The supporting layer 200 contains the supporting polymer 210. The supporting polymer 210 may be any suitable thermoplastic that is co-extrudable which the choice of first polymer 120 and second polymer 140. The supporting polymer 210 may be selected from the listing of possible thermoplastic polymers listed for the first polymer 120 and the second polymer 140. In one embodiment, the supporting polymer 210 is the same polymer as the second polymer 140 or is soluble in the same solvent as the second polymer 140. This always the matrix (second polymer) 140 and the supporting layer 200 to be removed at the same time leaving just the nanofibers 120. In another embodiment, the supporting polymer 210 is a different polymer than the second polymer 140 and is not soluble in the same solvents as the second polymer 140. This produces a nanofiber non-woven on the supporting layer after removing the second polymer 140 which is advantageous for applications that require a non-woven having increased dimensional stability and strength. The supporting layer 200 may also control the depth of penetration of the nanofibers into a material (such as a textile layer) during consolidation.

The supporting layer thickness may be tuned to create the described concentration gradient or lack thereof in the resultant nanofiber layer 100. The supporting layer may also contain any other suitable material including but not limited to nanofibers, micron sized fibers, nano-particles, conductive particles, flame retardants, supporting structures such as scrims, and antimicrobials.

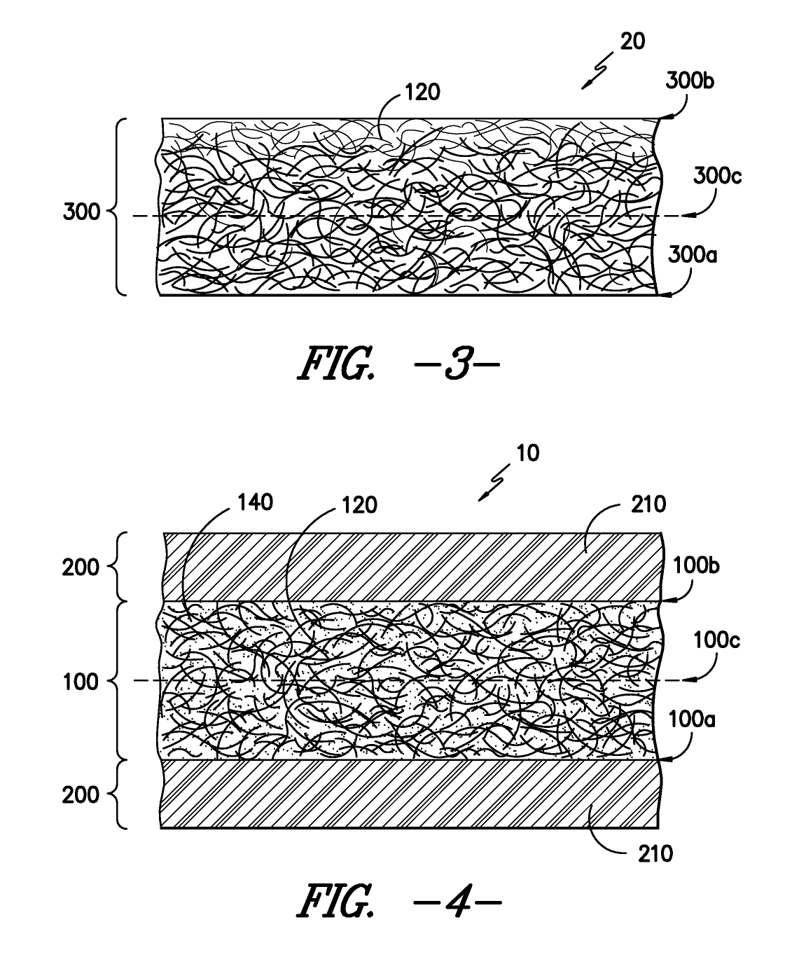

When the matrix 140 (second polymer) is removed from the multi-layer nano-composite 10 shown in FIG. 1 having one nanofiber layer and one supporting layer, the non-woven composite 20 shown in FIG. 2 remains. The non-woven nano-composite 20 of FIG. 2 contains a non-woven layer 300 and the supporting layer 200. In the non-woven layer 300, the first outer boundary 300a is located at the surface of the non-woven layer 300 adjacent the supporting layer 200. The second outer boundary 300b is located on surface of the non-woven layer opposite the first outer boundary 300a. The inner boundary 300c is located at the mid-point plane between the first outer boundary layer 300a and the second outer boundary layer 300b. The inner boundary 300c is not a physical boundary, but an imaginary plane in the bulk of the non-woven layer 300. The nanofibers 120 within the non-woven layer 300 have a substantially uniform fiber size and density from the inner boundary 300c to the first outer boundary 300a. Moving from the inner boundary 300c to the second outer boundary layer 300b the size of the nanofibers decreases and the density of the nanofibers increases. The non-woven nano-composite 20 may be used for any suitable purpose including facial oil absorption.

In a facial oil absorption application, the non-woven layer 300 absorbs the oil efficiently because of the small diameter of the fibers, the bonding of the nanofibers 120 within the non-woven layer 300 increases the durability, and the supporting layer 200 provides strength and support for the non-woven layer 300. When oil is absorbed by the non-woven layer 300, the non-woven layer 300 may change from white or opaque to translucent or transparent as the oil has a much closer index of refraction to the thermoplastic nanofibers than the air the oil replaced. This color or transparency change can indicate to users that the non-woven nano-composite 20 has absorbed oil and may be nearing its maximum oil absorption amount.

When the matrix 140 (second polymer) and the supporting layer 200 are removed from the multi-layer nano-composite 10 shown in FIG. 1, the nano-porous non-woven 30 shown in FIG. 3 remains. The nanofibers 120 within the non-woven layer 300 have a substantially uniform fiber size and density from the inner boundary 300c to the first outer boundary 300a. Moving from the inner boundary 300c to the second outer boundary layer 300b the size of the nanofibers decreases and the density of the nanofibers increases. The nano-porous non-woven 30 may be used for any suitable purpose that would require a non-woven made of nanofibers where at least 70% of the nanofibers are bonded to other nanofibers and would require a gradient of fiber size and concentration.

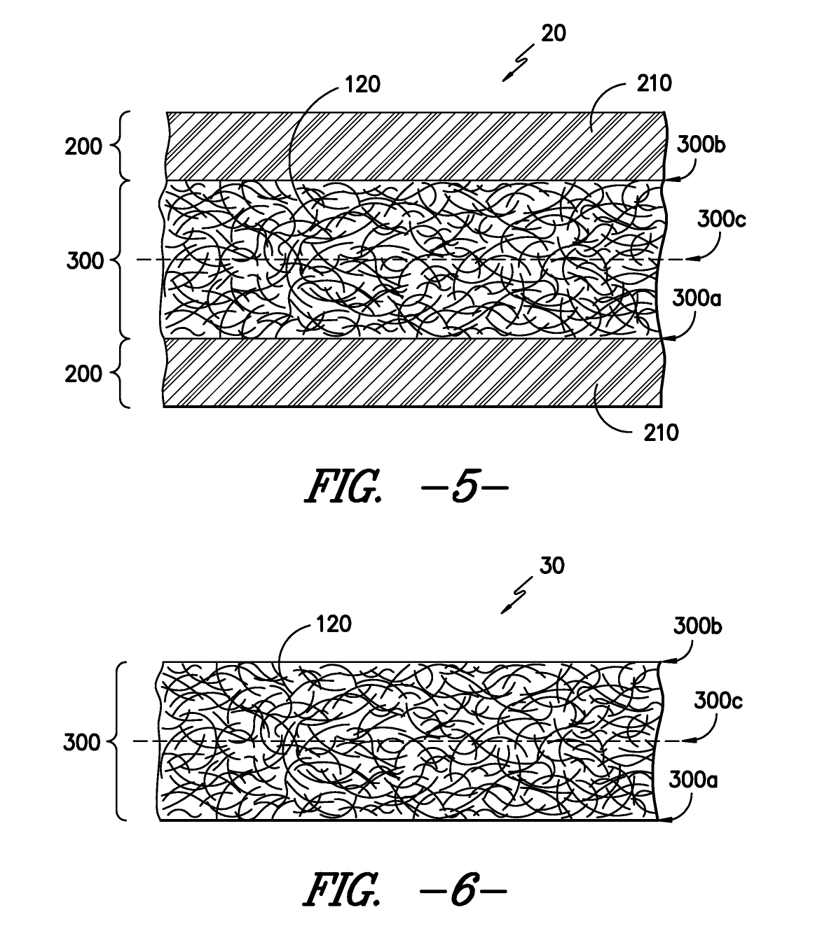

FIG. 4 illustrates an embodiment where the nanofiber layer 100 is surrounded on both sides by supporting layers 200. Having supporting layers 200 on both sides of the nanofiber layer 100 creates a more uniform distribution (of in both concentration and size) of nanofibers 120 across the entire thickness of the nanofiber layer 100 (from 100a to 100b). While FIG. 2 shows that the supporting layers each contain the same supporting polymer 210, each supporting layer 200 may contain different supporting polymers and/or different additives or amounts of additives.

In one embodiment, one of the supporting layers 200 contain a supporting polymer 210 that is the same polymer as the second polymer 140 or is soluble in the same solvent as the second polymer 140. This allows the matrix (second polymer) 140 and one of the supporting layers 200 (a sacrificial layer) to be removed at the same time leaving a non-woven nano-composite. In another embodiment, both of the supporting layers 200 contain a supporting polymer 210 that is the same polymer as the second polymer 140 or is soluble in the same solvent as the second polymer 140. This allows the matrix (second polymer) 140 and both of the supporting layers 200 to be removed at the same time leaving a nano-porous non-woven 300. In another embodiment, the supporting polymers 210 of the supporting layers 200 are both a different polymer than the second polymer 140 and are not soluble in the same solvents as the second polymer 140. This produces a nanofiber non-woven with two supporting layers after removing the second polymer 140.

When the matrix 140 (second polymer) is removed from the multi-layer nano-composite 10 shown in FIG. 4, the nano-porous non-woven 30 shown in FIG. 5 remains having one nano-porous non-woven layer 300 surrounded on both sides by supporting layers 200. The nanofibers 120 within the non-woven layer 300 have a substantially uniform fiber size and density from the first outer boundary 300a to the second outer boundary 300b.

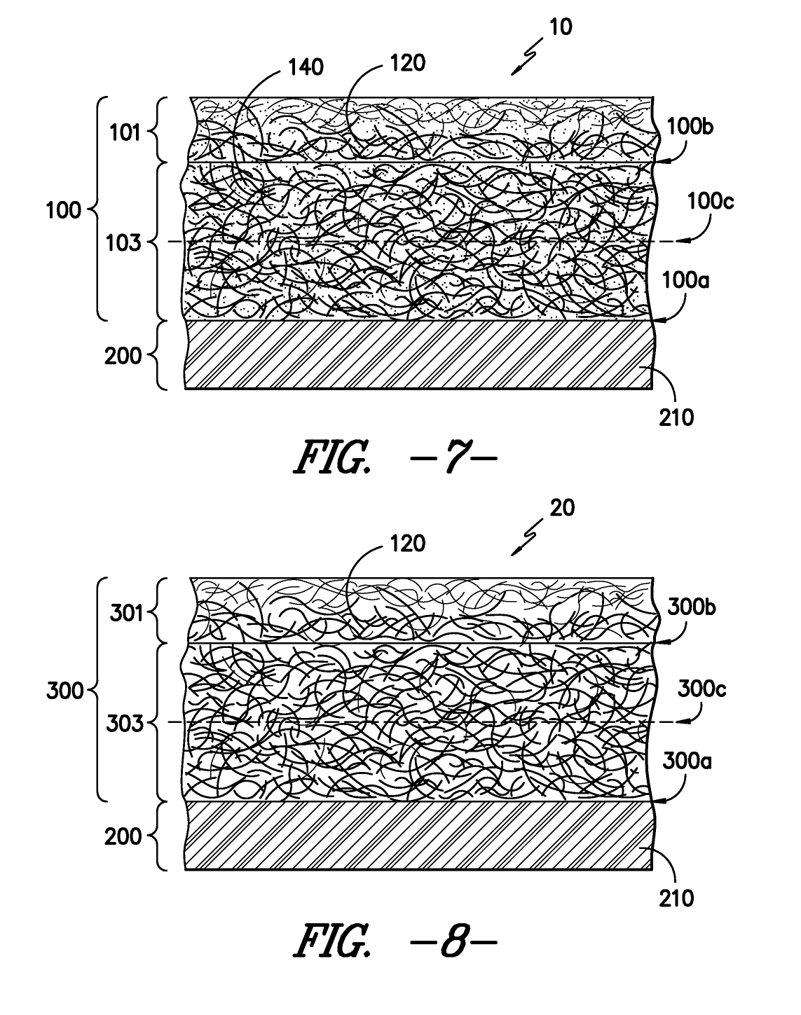

When the matrix 140 (second polymer) and the supporting layers 200 are removed from the multi-layer nano-composite 10 shown in FIG. 4, the nano-porous non-woven 30 shown in FIG. 6 remains. The nanofibers 120 within the non-woven layer 300 have a substantially uniform fiber size and density from the first outer boundary 300a to the second outer boundary 300b. The nano-porous non-woven 30 may be used for any suitable purpose that would require a non-woven made of nanofibers where at least 70% of the nanofibers are bonded to other nanofibers and would require a uniform distribution of nanofibers in both concentration and fiber size.

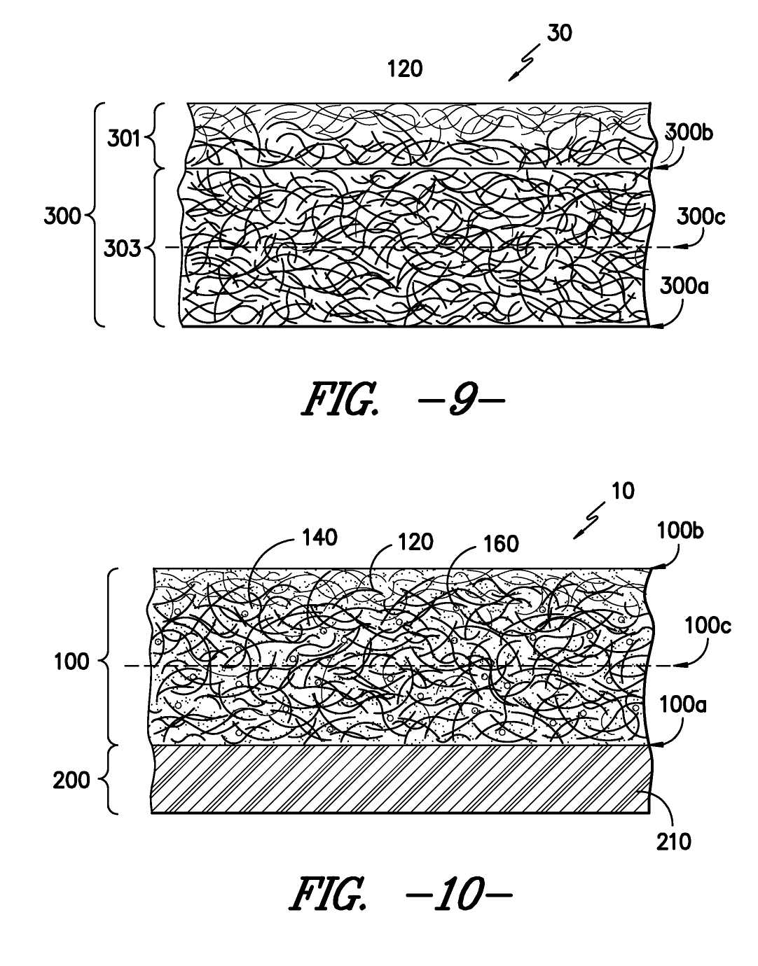

In some embodiments, the nanofiber layer 300 contains multiple sub-layers. The nanofiber layer 100 may contain any suitable number of sub-layers including 2, 3, 4, or more sub-layers. The nanofiber layer 100 shown in FIG. 7 has two sub-layers 101 and 103. Each of the sub-layers may contain the same or different first polymer, second polymer, concentrations of the first and second polymer, and/or additives. This thicknesses of the sub-layers may also be the same or different. Multiple sub layers can be beneficial to many applications, such as battery separators for lithium ion batteries where both mechanical strength and fast shutdown speed are achieved by different layers, each having differing filter characteristics. When the matrix 140 is removed from all of the sub-layers 101, 103 of the nanofiber layer 100, the non-woven nano-composite 20 as shown in FIG. 8 remains. When the matrix 140 of the sub-layers 101, 103 of the nanofiber layer 100 and the supporting polymer 210 of the supporting layer 200 is removed, the nano-porous non-woven 30 as shown in FIG. 9 remains. A layer with different concentrations of polymer could also have different degrees of porosity and pore sizes within this layer. Materials, such as this, containing pore size gradients have been shown to give superior behavior as filtration membranes.

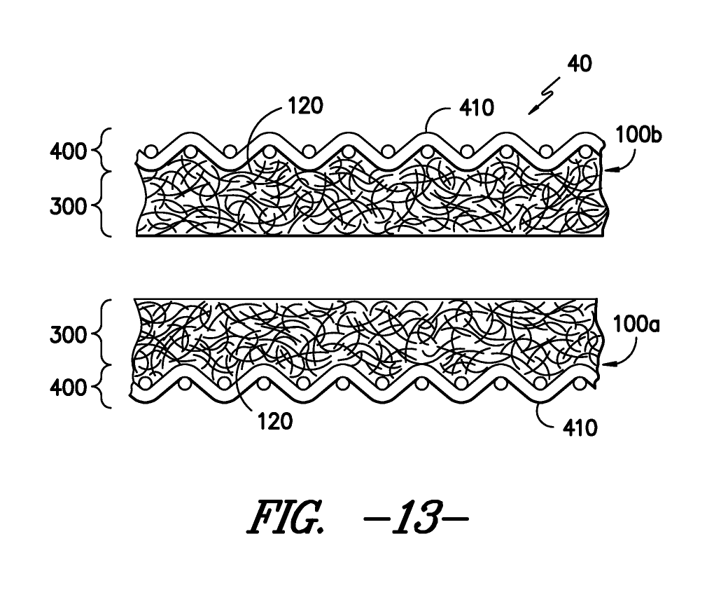

FIG. 12 illustrates a fiver (5) layer multi-layer nano-composite 40. The layers are, in order, a textile material 400, a nanofiber layer 100, a supporting layer 200, a nanofiber layer 100, and a textile material 400.

The textile material 400 may be any suitable textile material including, but not limited to knit, woven, non-woven, and unidirectional. The two textile materials 400 may be the same or different and may be formed from any suitable fibers and/or yarns including natural and man-made. Woven textiles can include, but are not limited to, satin, twill, basket-weave, poplin, and crepe weave textiles. Jacquard woven textiles may be useful for creating more complex electrical patterns. Knit textiles can include, but are not limited to, circular knit, reverse plaited circular knit, double knit, single jersey knit, two-end fleece knit, three-end fleece knit, terry knit or double loop knit, warp knit, and warp knit with or without a micro denier face. The textile may be flat or may exhibit a pile.

As used herein yarn shall mean a continuous strand of textile fibers, spun or twisted textile fibers, textile filaments, or material in a form suitable for knitting, weaving, or otherwise intertwining to form a textile. The term yarn includes, but is not limited to, yarns of monofilament fiber, multifilament fiber, staple fibers, or a combination thereof. The textile material may be any natural or man-made fibers including but not limited to man-made fibers such as polyethylene, polypropylene, polyesters (polyethylene terephthalate, polybutylene terephthalate, polytrimethylene terephthalate, polylactic acid, and the like, including copolymers thereof), nylons (including nylon 6 and nylon 6,6), regenerated cellulosics (such as rayon), elastomeric materials such as Lycra™, high-performance fibers such as the polyaramids, polyimides, PEI, PBO, PBI, PEEK, liquid-crystalline, thermosetting polymers such as melamine-formaldehyde (BASOFIL™) or phenol-formaldehyde (KYNOL™), basalt, glass, ceramic, cotton, coir, bast fibers, proteinaceous materials such as silk, wool, other animal hairs such as angora, alpaca, or vicuna, and blends thereof.

When the supporting layer 200 and the second polymer 140 are removed, two non-woven nano-composites remain, each with one layer of a non-woven layer 300 and a textile material 400 as shown in FIG. 13. The multi-layer nano-composite 40 may contain any suitable number of total layer, nanofiber layers, supporting layers, and textile materials in any suitable configuration.

In one embodiment, the matrix of the nanofiber layer 100 is a water vapor permeable material such as PEBAX resin, a block copolymer of nylon a polyether, by Arkema or a water vapor permeable thermoplastic polyurethane (TPU). The nanofibers in the layer reinforce the layer and also serve as a moisture barrier. When this layer is laminated on a fabric via extrusion coating or calendaring, a breathable water proof fabric composite is created without the matrix material (second polymer) having to be removed.

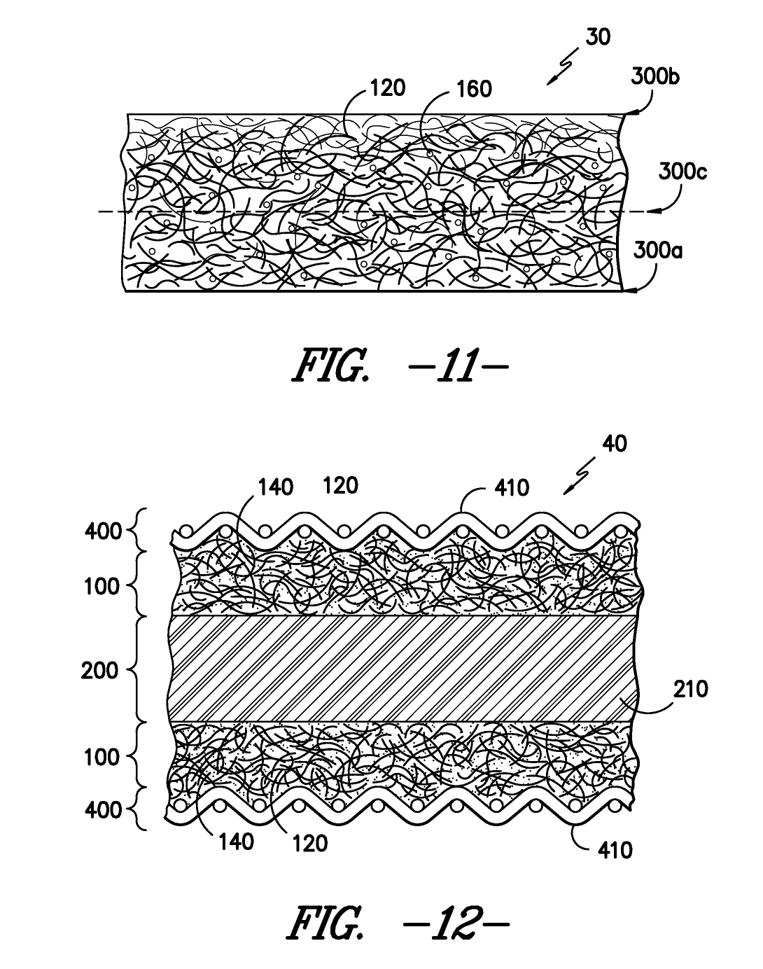

FIG. 10 illustrates a multi-layer nano-composite 10 containing one supporting layer 200 and one nanofiber layer 100. The nanofiber layer 160 additionally contains nano-particles 160. FIG. 11 illustrates that resultant nano-porous non-woven 30 that remains once the supporting layer 200 and second polymer 140 are removed. Nano-porous materials containing nano-particles could be used in catalysis or as selective adsorption/separation materials.

In one embodiment, the multi-layer nano-composite may contain any suitable particle, including nano-particles, micron-sized particles or larger. “Nano-particle” is defined in this application to be any particle with at least one dimension less than one micron. The particles may be, but are not limited to, spherical, cubic, cylindrical, platelet, and irregular. Preferably, the nano-particles used have at least one dimension less than 800 nm, more preferably less than 500 nm, more preferably, less than 200 nm, more preferably less than 100 nm. The particles may be organic or inorganic.

Examples of suitable organic particles include buckminsterfullerenes (fullerenes), dendrimers, organic polymeric nanospheres, aminoacids, and linear or branched or hyperbranched “star” polymers such as 4, 6, or 8 armed polyethylene oxide with a variety of end groups, polystyrene, superabsorbing polymers, silicones, crosslinked rubbers, phenolics, melamine formaldehyde, urea formaldehyde, chitosan or other biomolecules, and organic pigments (including metallized dyes).

Examples of suitable inorganic particles include, but are not limited to, calcium carbonate, calcium phosphate (e.g., hydroxy-apatite), talc, mica, clays, metal oxides, metal hydroxides, metal sulfates, metal phosphates, silica, zirconia, titania, ceria, alumina, iron oxide, vanadia, antimony oxide, tin oxide, alumina/silica, zirconium oxide, gold, silver, cadmium selenium, chalcogenides, zeolites, nanotubes, quantum dots, salts such as CaCO₃, magnetic particles, metal-organic frameworks, and any combinations thereof.

In one embodiment, the particles are further functionalized. Via further chemistry, the third surface of the particles may have added functionality (reactivity, catalytically functional, electrical or thermal conductivity, chemical selectivity, light absorbtion) or modified surface energy for certain applications.

In another embodiment, particles are organic-inorganic, coated, uncoated, or core-shell structure. In one embodiment, the particles are PEG (polyethylene glycol) coated silica, PEG coated iron oxide, PEG coated gold, PEG coated quantum dots, hyperbranched polymer coated nano-clays, or other polymer coated inorganic particles such as pigments. The particles, in one embodiment, may melt and re-cool in the process of forming the nanofiber non-woven. The particles may also be an inorganic core -inorganic shell, such as Au coated magnetic particles. The particles, in one embodiment, may melt and re-cool in the process of forming the nanofiber non-woven. In another embodiment, the particles are ZELEC®, made by Milliken and Co. which has a shell of antimony tin oxide over a core that may be hollow or solid, mica, silica or titania. A wax or other extractible coating (such as functionalized copolymers) may cover the particles to aid in their dispersion in the matrix polymer.

In one embodiment, the nanofibers are core/shell nanofibers. The cores and shells may have any suitable thickness ratio depending on the end product. The core (formed from the first polymer) of the nanofiber extends the length of the nanofiber and forms the center of the nanofiber. The shell of the fiber at least partially surrounds the core of the nanofiber, more preferably surrounds approximately the entire outer surface of the core. Preferably, the shell covers both the length of the core as well as the smaller ends of the core. The shell polymer may be any suitable polymer, preferably selected from the listing of polymers for the first polymer and the second polymer.

At least a portion of the core polymer interpenetrates the shell of the nanofiber and at least a portion of the shell polymer interpenetrates the core of the nanofiber. This occurs as the core and shell polymers are heated and formed together. The polymer chains from the core polymers interpenetrate the shell and the polymer chains from the shell polymer interpenetrate the core and the core and shell polymers intermingle. This would not typically occur from a simple coating of already formed nanofibers with a coating polymer.

In one embodiment, the matrix polymer is polystyrene and the core polymer could be linear low density polyethylene (LLDPE), high density polyethylene (HDPE), isotactic polypropylene (iPP), polyethylene terephthalate (PET), polytrimethylene terephthalate (PTT), polybutylene terephthalate (PBT), poly(butylene adipate terephthalate) (PBAT), poly(Ethylene terephthalate-co-isophthalate)-poly(ethylene glycol) (IPET-PEG), and a highly modified cationic ion-dyeable polyester (HCDP).

The core and shell polymers may be chosen with to have a different index of refraction or birefringence for desired optical properties. In another embodiment, the core polymer is soluble in a second solvent (which may be the same solvent or different solvent as the first solvent) such that the core of the core/shell nanofibers may be removed leaving bonded hollow nanofibers.

In another embodiment, the multi-layer nano-composite contains at least one textile layer which may be any suitable textile layer. The textile layer may be on one or both sides of the multi-layer nano-composite, or between some layers of the multi-layer nano-composite. If more than one textile layer is used, they may each contain the same or different materials and constructions. In one embodiment, the textile layer is selected from the group consisting of a knit, woven, non-woven, and unidirectional layer. The textile layer provides turbulence of the molten mixture of the first and second polymer during extrusion and/or subsequent consolidation causing nanofiber movement, randomization, and bonding. The textile layer may be formed from any suitable fibers and/or yarns including natural and man-made. Woven textiles can include, but are not limited to, satin, twill, basket-weave, poplin, and crepe weave textiles. Jacquard woven textiles may be useful for creating more complex electrical patterns. Knit textiles can include, but are not limited to, circular knit, reverse plaited circular knit, double knit, single jersey knit, two-end fleece knit, three-end fleece knit, terry knit or double loop knit, warp knit, and warp knit with or without a micro denier face. The textile may be flat or may exhibit a pile. The textile layer may have any suitable coating upon one or both sides, just on the surfaces or through the bulk of the textile. The coating may impart, for example, soil release, soil repel/release, hydrophobicity, and hydrophilicity.

As used herein yarn shall mean a continuous strand of textile fibers, spun or twisted textile fibers, textile filaments, or material in a form suitable for knitting, weaving, or otherwise intertwining to form a textile. The term yarn includes, but is not limited to, yarns of monofilament fiber, multifilament fiber, staple fibers, or a combination thereof. The textile material may be any natural or man-made fibers including but not limited to man-made fibers such as polyethylene, polypropylene, polyesters (polyethylene terephthalate, polybutylene terephthalate, polytrimethylene terephthalate, polylactic acid, and the like, including copolymers thereof), nylons (including nylon 6 and nylon 6,6), regenerated cellulosics (such as rayon), elastomeric materials such as Lycra™, high-performance fibers such as the polyaramids, polyimides, PEI, PBO, PBI, PEEK, liquid-crystalline, thermosetting polymers such as melamine-formaldehyde (BASOFIL™) or phenol-formaldehyde (KYNOL™), basalt, glass, ceramic, cotton, coir, bast fibers, proteinaceous materials such as silk, wool, other animal hairs such as angora, alpaca, or vicuna, and blends thereof.

The process for forming a multi-layer nano-composite begins with blending a first polymer and a second polymer in a molten state 100. The first polymer forms discontinuous regions in the second polymer. These discontinuous regions may be nano-, micro-, or larger sized liquid drops dispersed in the second polymer. The first polymer forms the nanofibers and the second polymer forms the matrix in the nanofiber layer. This blend may be cooled and re-heated before co-extrusion or used directly in the extrusion process.

The molten polymer blend of the first and second polymer is, in one embodiment, co-extruded with at least one supporting layer being subjected to extensional flow and shear stress such that the first polymer forms nanofibers within the matrix of the second polymer. The extensional flow and shear stress may be from, for example, extrusion through a slit die, a blown film extruder, a round die, injection molder, or a fiber extruder. These materials may then be subsequently drawn further in either the molten or softened state.

The nanofibers formed have an aspect ratio of at least 5:1 (length to diameter), more preferably, at least 10:1, at least 50:1, at least 100:1, and at least 1000:1. The nanofibers are generally aligned along an axis, referred to herein as the “nanofiber axis”. Preferably, at least 80% of the nanofibers are aligned within 20 degrees of this axis. After the extensional flow less than 30% by volume of the nanofibers are bonded to other nanofibers. This means that at least 70% of the nanofibers are not bond (adhered or otherwise) to any other nanofiber. Should the matrix (second polymer) by removed at this point, the result would be mostly separate individual nanofibers. In another embodiment, after step 200, less than 20%, less than 10%, or less than 5% of the nanofibers are bonded to other nanofibers. The supporting layer(s) experience variations in the extensional force during extrusion depending on the distance from the surface of the composite. The closer the layer to the surface the smaller in diameter the nanofibers are and the closer the layer to the center region of the entire extruded composite the larger the diameter of the nanofibers.

The co-extruded layers are cooled to a temperature below the softening temperature of the first polymer to preserve the nanofiber shape. “Softening temperature” is defined to be the temperature where the polymers start to flow. For crystalline polymers, the softening temperature is the melting temperature. For amorphous polymers, the softening temperature is the Vicat temperature. These cooled co-extruded layers form the first intermediate.

Next, the first intermediate is formed into a pre-consolidation formation in step 400. Forming the first intermediate into a pre-consolidation formation involves arranging the first intermediate into a form ready for consolidation. The pre-consolidation formation may be, but is not limited to, a single film, a stack of multiple films, a fabric layer (woven, non-woven, knit, unidirectional), a stack of fabric layers, a layer of powder, a layer of polymer pellets, an injection molded article, or a mixture of any of the previously mentioned. The polymers in the pre-consolidation formation may be the same through the layers and materials or vary. In one embodiment, the pre-consolidation formation is the co-extruded layers placed over a textured surface (such as a fabric or textured roller).

In a first embodiment, the pre-consolidation formation is in the form of a fabric layer. In this embodiment, the co-extruded layers are extruded into fibers (could be core/shell, islands in the sea, or any other multi-component fiber) which form the first intermediate. The fibers of the first intermediate are formed into a woven, non-woven, knit, or unidirectional layer. This fabric layer may be stacked with other first intermediate layers such as additional fabric layers or other films or powders.

In another embodiment, the pre-consolidation formation is in the form of a film layer. In this embodiment, the molten polymer blend is extruded into a film which forms the first intermediate. The film may be stacked with other films or other first intermediate layers. The film may be consolidated separately or layered with other films. In one embodiment, the films are stacked such that the nanofiber axes all align. In another embodiment, the films are cross-lapped such that the nanofiber axis of one film is perpendicular to the nanofiber axes of the adjacent films forming the pre-consolidation formation 410. If two or more films are used, they may each contain the same or different polymers. For example, a PP/PS 80/20 (by weight) film may be stacked with a PP/PS 75/25 (by weight) film. Additionally, a PE/PS film may be stacked on a PP/PS film. Other angles for cross-lapping may also be employed.

In another embodiment, the pre-consolidation formation is in the form of a structure of co-extruded pellets, which may be a flat layer of pellets or a three-dimensional structure. In this embodiment, the molten polymer blend is extruded into a fiber, film, tube, elongated cylinder or any other shape and then is pelletized which forms the first intermediate. Pelletizing means that the larger cooled polymer blend is chopped into finer components. The most common pelletizing method is to extrude a pencil diameter fiber, then chop the cooled fiber into pea-sized pellets. The pellets may be covered or layered with any other first intermediate structures such as fabric layers or film layers.

In another embodiment, the pre-consolidation formation is in the form of a structure of a powder of the co-extruded layers, which may shaped into be a flat layer of powder or a three-dimensional structure. In this embodiment, the molten polymer blend is extruded, cooled, and then ground into a powder which forms the first intermediate. The powder may be covered or layered with any other first intermediate structures such as fabric layers or film layers.

In another embodiment, the pre-consolidation formation is in the form of a structure of an injection molded at least 2 layer article. The injection molded first intermediate may be covered or layered with any other first intermediate structures such as fabric layers or film layers.

Additionally, the pre-consolidation formation may be layered with other layers (not additional first intermediates) such as fabric layers or other films not having nanofibers or embedded into additional layers or matrixes. One such example would be to embed first intermediate pellets into an additional polymer matrix. The pre-consolidation layer may also be oriented by stretching in at least one axis.

Consolidation is conducted at a temperature is above the T_{g} and of both the first polymer and second polymer of the nanofiber layer and within 50° C. of the softening temperature of first polymer. More preferably, consolidation is conducted at 20° C. of the softening temperature of the first polymer. The consolidation temperature upper limit is affected by the pressure of consolidation and the residence time of consolidation. For example, a higher consolidation temperature may be used if the pressure used is high and the residence time is short. If the consolidation is conducted at a too high a temperature, too high a pressure and/or too long a residence time, the fibers might melt into larger structures or revert back into discontinuous or continuous spheres.

Consolidating the pre-consolidation formation causes nanofiber movement, randomization, and at least 70% by volume of the nanofibers to fuse to other nanofibers. This forms the second intermediate. This movement, randomization, and bonding of the nanofibers may be accomplished two ways: one being that the pre-consolidation formation contains multiple nanofiber axes. This may arise, for example, from stacking cross-lapped first intermediate layers or using a non-woven, or powder. When heat and pressure is applied during consolidation, the nanofibers move relative to one another and bond where they interact. Another method of randomizing and forming the bonds between the nanofibers is to use a consolidation surface that is not flat and uniform. For example, if a textured surface or fabric were used, even if the pressure was applied uniformly, the flow of the matrix and the nanofibers would be turbulent around the texture of the fabric yarns or the textured surface causing randomization and contact between the nanofibers. If one were to simply consolidate a single layer of film (having most of the nanofibers aligned along a single nanofiber axis) using a press that delivered pressure perpendicular to the plane of the film, the nanofibers would not substantially randomize or bond and once the matrix was removed, predominately individual (unattached) nanofibers would remain. Preferably, at least 75% vol of the nanofibers to bond to other nanofibers, more preferably at least 85% vol, more preferably at least 90% vol, more preferably at least 95% vol, more preferably at least 98% vol.

At applied pressure and temperature, the second polymer is allowed to flow and compress resulting in bringing “off-axis” nanofibers to meet at the cross over points and fuse together. Additional mixing flow of the second polymer may also be used to enhance the mixing and randomization of the off-axis fibers. One conceivable means is using a textured non-melting substrate such as a fabric (e.g. a non-woven), textured film, or textured calendar roll in consolidation. Upon the application of pressure, the local topology of the textured surface caused the second polymer melt to undergo irregular fluctuations or mixing which causes the direction of the major axis of the nanofibers to alter in plane, resulting in off-axis consolidations. In a straight lamination or press process, due to the high melt viscosity and flow velocity, the flow of the second polymer melt is not a turbulent flow and cross planar flow is unlikely to happen. When the majority of the nanofibers are in parallel in the same plane, the nanofibers will still be isolated from each other, resulting in disintegration upon etching.

In some embodiments, the second polymer and/or the supporting polymer may be removed. A small percentage (less than 30% vol) may be removed, most, or all of the second polymer and/or supporting polymer may be removed. If just a portion of the second polymer is removed, it may be removed from the outer surface of the intermediate leaving the nano-composite having a nanofiber non-woven surrounding the center of the article which would remain a nano-composite. The removal may be across one or more surfaces of the second intermediate or may be done pattern-wise on the second intermediate. Additionally, the second polymer may be removed such that there is a concentration gradient of the second polymer in the final product with the concentration of the second polymer the lowest at the surfaces of the final product and the highest in the center. The concentration gradient may also be one sided, with a concentration of the second polymer higher at one side.

If essentially the entire or the entire second polymer and supporting polymer is removed from the second intermediate, what remains is a nano-porous non-woven, where at least 70% vol of the nanofibers are bonded to other nanofibers. While the resultant structure is described as a nano-porous non-woven, the resultant structure may consist of a non-woven formed from bonded nanofibers and resemble a non-woven more than a film. The bonding between the nanofibers provides physical integrity for handling of the etched films/non-woven in the etching process which makes the use of a supporting layer optional. Smearing and/or tearing of the nanofibers upon touching is commonly seen in the poorly consolidated second intermediates. The second polymer and/or the supporting polymer may be removed using a suitable solvent or decomposition method described above.

The benefit of the process of consolidating the pre-consolidation layer is the ability to form the bonds between the nanofibers without losing the nanofiber structure. If one were to try to bond the nanofibers in a nanofiber non-woven, when heat is applied, the nanofibers would all melt together and the nanofibers would be lost. This would occur when the heat is uniform, such as a lamination or nip roller, or is specific such as spot welding or ultrasonics.

The final product or any of the intermediates in the process may be used for different applications that they are suitable for.

In one embodiment, the multi-layer nano-composite 10, non-woven nano-composite 20, and/or the nano-porous non-woven 30 may contain additional microfibers and/or engineering fibers. Engineering fibers are characterized by their high tensile modulus and/or tensile strength. Engineering fibers include, but are not limited to, E-glass, S-glass, boron, ceramic, carbon, graphite, aramid, poly(benzoxazole), ultra high molecular weight polyethylene (UHMWPE), and liquid crystalline thermotropic fibers. The use of these additional fibers in the composites and non-wovens/films may impart properties that may not be realized with a single fiber type. For example, the high stiffness imparted by an engineering fiber may be combined with the low density and toughness imparted by the nanofibers. The extremely large amount of interfacial area of the nanofibers may be effectively utilized as a means to absorb and dissipate energy, such as that arising from impact. In one embodiment a nanofibers mat comprised of hydrophobic nanofibers is placed at each of the outermost major surfaces of a mat structure, thereby forming a moisture barrier for the inner layers. This is especially advantageous when the inner layers are comprised of relatively hydrophilic fibers such as glass.

In one embodiment, the bonded nanofibers may improve the properties of existing polymer composites and films by providing nanofiber-reinforced polymer composites and films, and corresponding fabrication processes, which have a reduced coefficient of thermal expansion, increased elastic modulus, improved dimensional stability, and reduced variability of properties due to either process variations or thermal history. Additionally, the increased stiffness of the material due to the nanofibers may be able to meet given stiffness or strength requirements.

The bonded nanofibers of the nano-porous non-woven 30 may be used in many known applications employing nanofibers including, but not limited to, filter applications, catalysis, adsorbtion and separation applications, computer hard drive applications, biosensor applications and pharmaceutical applications. The nanofibers are useful in a variety of biological applications, including cell culture, tissue culture, and tissue engineering applications. In one application, a nanofibrillar structure for cell culture and tissue engineering may be fabricated using the nanofibers of the present invention.

### EXAMPLES

Various embodiments are shown by way of the Examples below, but the scope of the invention is not limited by the specific Examples provided herein.

### Example 1

Example 1 was a mono-extruded nanofiber layer and did not contain any supporting layers. The first polymer used to form the nanofibers was Homopolymer Polypropylene (HPP), obtained in granule form from Lyondell Basell as Pro-fax 6301 and had a melt flow of 12 g/10 min (230° C., ASTMD 1238). The granule HPP was pelletized using a twin screw extruder Prism TSE 16TC. The second polymer used to form the matrix was Cyrtal Polystyrene (PS), obtained in pellet form from Total Petrochemicals as PS 535 and had a melt flow of 14 g/10 min (200° C., ASTMD 1238). The PS and HPP pellets were premixed in a mixer at a weight ratio of 80/20. The mixture was fed into a co-rotating 16 mm twin-screw extruder, Prism TSE 16TC. The feed rate was 150 g min⁻¹ and the screw speed was 92 rpm. Barrel temperature profiles were 225, 255, 245, 240, and 235° C. The blend was extruded through a slit die to form a 25 micron film where the extrudate was subject to an extensional force that was sufficient to generate nanofibrillar structure. This film was the first intermediate.

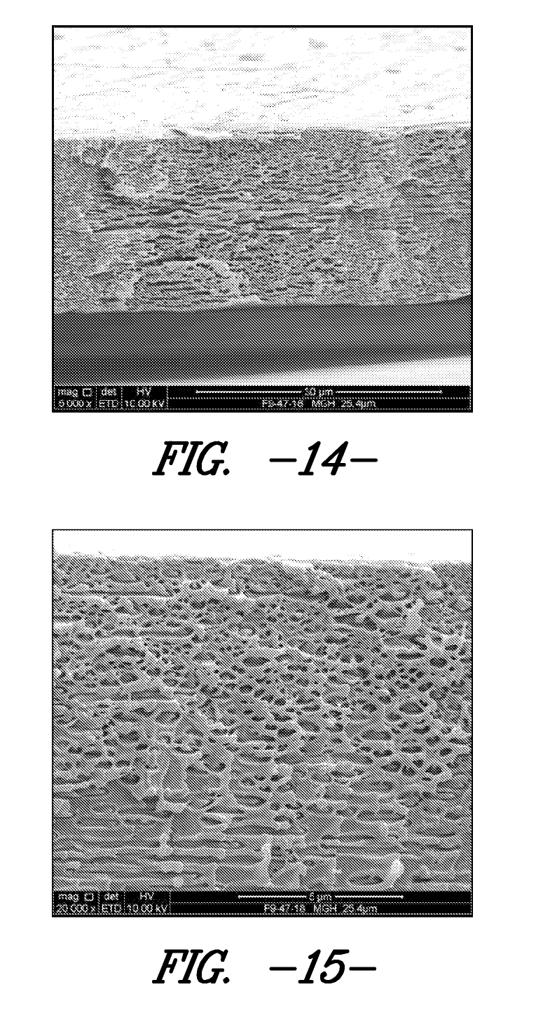

The cross section of the cryofractured film (first intermediate) was examined via SEM in the direction normal to the machine direction. The PP fibers were normal to the field of view. The diameters of the PP fibers range from 100 nm to 500 nm. It can be in seen FIGS. 14 and 15 that the PP fibers are finer and denser close to the surfaces of the film indicating higher shear rate near the edges. These fiber distribution characteristics are a result of the non-uniformity of the flow field across the film die during extrusion.

### Example 2

The nanofiber layer of Example 1 was immersed in toluene at room temperature for 30 minutes to remove PS from the blends as PS is soluble in toluene and PP is insoluble in toluene. This step was repeated for two more times to ensure complete removal of polystyrene. The etched film was then immersed in acetone and methanol for 30 minutes respectively, then air dried. The sample had no structural integrity and fell apart.

### Example 3

Example 3 was a co-extruded multi-layer nano-composite having a nanofiber layer surrounded on both sides by supporting layers. In the nanofiber layer, the first polymer used to form the nanofibers was Homopolymer Polypropylene (HPP), obtained in granule form from Lyondell Basell as Pro-fax 6301 and had a melt flow of 12 g/10 min (230° C., ASTMD 1238). The granule HPP was pelletized using a twin screw extruder Prism TSE 16TC. The second polymer used to form the matrix was Cyrtal Polystyrene (PS), obtained in pellet form from Total Petrochemicals as PS 535 and had a melt flow of 14 g/10 min (200° C., ASTMD 1238). The PS and HPP pellets were premixed in a mixer at a weight ratio of 80/20. The mixture was fed into a co-rotating 16 mm twin-screw extruder, Prism TSE 16TC. The feed rate was 150 g min⁻¹ and the screw speed was 92 rpm. Barrel temperature profiles were 225, 255, 245, 240, and 235° C. The blend was then co-extruded with two supporting layers each being formed from Crystal Polystyrene PS 535. The resultant three layer film, PS/(PS/PP)/PS with a thickness of 10 um in each layer. The co-extruded film was the first intermediate.

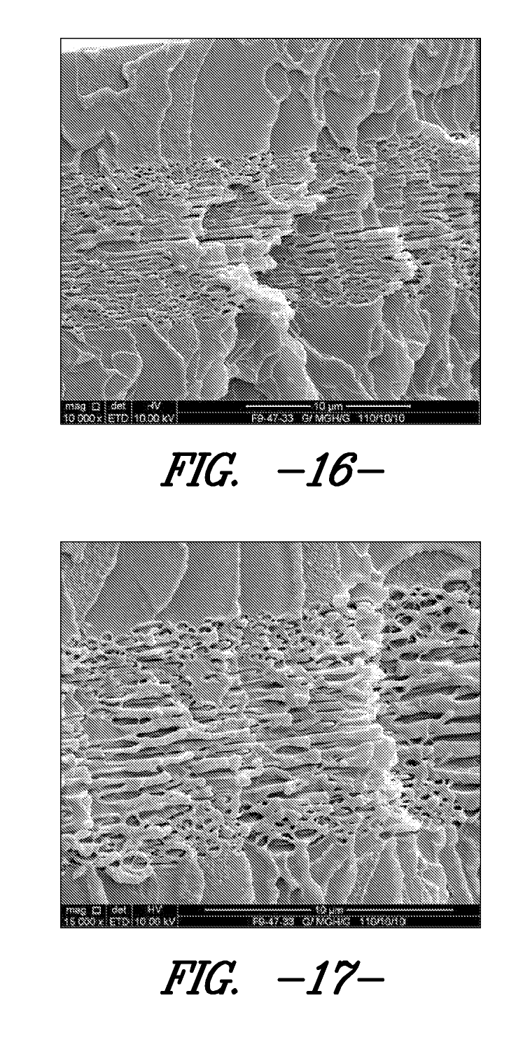

The cross section of this film was examined via SEM. Again, the cross section is normal to the machine direction. In FIGS. 16 and 17, it can be seen that the gradient of the PP fiber size across the PS/PP 80/20 region was significantly decreased by using two PS layers on the sides of the nanofiber layer resulting in nanofibers that were substantially uniform from the outer edges of the nanofiber layer compared to the middle of the nanofiber layer.

### Example 4

The multi-layer nano-composite of Example 3 was calendared together with a nylon woven fabric to emboss the film with a fabric texture at 260° F. at a calendar speed of 20 ft/min. The resulting film was then immersed in toluene at room temperature for 30 minutes to remove PS from the nanofiber layer and the supporting layers as PS is soluble in toluene and PP is insoluble in toluene. This step was repeated for two more times to ensure complete removal of polystyrene. The etched film was then immersed in acetone and methanol for 30 minutes respectively, then air dried. A nano-porous non-woven was obtained. The fibers size and density were substantially uniform throughout the thickness of the nano-porous non-woven.

### Example 5

Example 5 was made with the same materials and method as Example 3 except for that nanofiber layers were used with different concentrations of the first and second polymers. The first nanofiber layer had a PS/PP weight ratio of 80/20 and the second nanofiber layer had a PS/PP weight ratio of 90/10. The resultant structure was PS/(PS/PP 80/20)/(PS/PP 90/10)/PS, each layer being 10 microns thick. The size and density of the nanofibers were substantially uniform throughout the thickness of each nano-fiber layer.

### Example 6

The multi-layer nano-composite of Example 5 was calendared together with a nylon woven fabric to emboss the film with a fabric texture at 260° F. at a calendar speed of 20 ft/min. The resulting film was then immersed in toluene at room temperature for 30 minutes to remove PS from the nanofiber layer and the supporting layers as PS is soluble in toluene and PP is insoluble in toluene. This step was repeated for two more times to ensure complete removal of polystyrene. The etched film was then immersed in acetone and methanol for 30 minutes respectively, then air dried. A nano-porous non-woven was obtained. The fibers size and density were substantially uniform throughout the thickness of the nano-porous non-woven. The size and density of the nanofibers and the density of the nano-particles were substantially uniform throughout the thickness of each nano-fiber layer.

### Example 7

Example 7 was made the same materials and method as Example 3, except for that the PS used the PS/PP layer was high impact polystyrene (Total HIPS 935E), but the sacrificial PS layer remained the same as the crystal polystyrene, PS 535. HIPS 935E it is a high-impact polystyrene by Total that contains reinforcing particles as an impact modifier.

### Example 8

The multi-layer nano-composite of Example 7 was calendared together with a nylon woven fabric to emboss the film with a fabric texture at 260° F. at a calendar speed of 20 ft/min. The resulting film was then immersed in toluene at room temperature for 30 minutes to remove PS from the nanofiber layer and the supporting layers as PS is soluble in toluene and PP is insoluble in toluene. This step was repeated for two more times to ensure complete removal of polystyrene. The etched film was then immersed in acetone and methanol for 30 minutes respectively, then air dried. A nano-porous non-woven was obtained. The size and density of the nanofibers and the density of the nano-particles were substantially uniform throughout the thickness of the nano-porous non-woven.

### Example 9

Example 9 was a multi-layer nano-composite having five (5) layers total. The layers were, in order, a textile material, a nanofiber layer, a supporting layer, a nanofiber layer, and a textile material. The nanofiber layer and supporting layers were the same as described in Example 3 and wee formed by co-extrusion. The textile material was a plain weave construction containing yarns of nylon 6. The supporting layers and the nanofiber layers have a thickness of 10 microns and the textile material had a thickness of 150 microns. The multi-layer nano-composite was heated to 320° F., with a pressure of 20 tons, for 15 minutes.

### Example 10

The resulting composite of Example 9 was then immersed in toluene at room temperature for 30 minutes to remove PS from the nanofiber layer and the supporting layers as PS is soluble in toluene and PP is insoluble in toluene. This step was repeated for two more times to ensure complete removal of polystyrene. The etched composite was then immersed in acetone and methanol for 30 minutes respectively, then air dried. The resultant structures were two nano-porous non-wovens each partially embedded into the textile layer.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A nano-composite article comprising
a nanofiber layer and a supporting layer which are co-extruded, wherein the nanofiber layer has a first outer boundary adjacent the supporting layer, a second outer boundary on the side of the nanofiber layer opposite the supporting layer and an inner boundary located at the mid-point between the first outer boundary and the second outer boundary and parallel to the first outer boundary, wherein;
the nanofiber layer comprises a matrix and a plurality of nanofibers, wherein at least 70% of the nanofibers are bonded to other nanofibers; and,
a supporting layer comprising a supporting polymer, wherein the supporting polymer is a thermoplastic polymer,
wherein the concentration of nanofibers are substantially uniform in the nanofiber layer from the inner boundary to the first boundary layer.

2. The nano-composite article of claim 1, further comprising a third layer comprising the supporting polymer, wherein the third layer is adjacent the second outer boundary layer and wherein the concentration of nanofibers in the nanofiber layer are substantially uniform from the first outer boundary layer to the second outer boundary layer.

3. The nano-composite article of claim 1, wherein the nanofiber layer comprises at least 2 sub-layers, wherein at least 2 of the sub-layers comprise a matrix and a plurality of nanofibers, wherein at least 70% of the nanofibers are bonded to other nanofibers.

4. The nano-composite of claim 3, wherein the sub-layers of the nanofiber layer comprise different percentage by weight of nanofibers.

5. The nano-composite of claim 3, wherein the nanofibers in the sub-layers of the nanofiber layer comprise different thermoplastics.

6. The nano-composite of claim 1, wherein the nanofiber layer further comprises nano-particles.

7. The nano-composite of claim 1, wherein the supporting layer further comprises nano-particles.

8. The nano-composite of claim 3, wherein the nanofiber layer comprises three sub-layers, wherein two of the sub-layers comprise a matrix and a plurality of nanofibers, wherein at least 70% of the nanofibers are bonded to other nanofibers and the third sub-layer comprises a thermoplastic.

9. The nano-composite of claim 1, wherein the supporting layer is essentially free of nano-fibers.

10. The nano-composite of claim 1, wherein the matrix of the nanofiber layer and the thermoplastic of the supporting layer are soluble in the same solvent.

11. The nano-composite of claim 1, wherein the matrix of the nanofiber layer and the thermoplastic of the supporting layer are the same thermoplastic.

12. The method of producing a nano-composite article comprising, in order:
a) co-extruding a nanofiber layer and a supporting layer, wherein the nanofiber layer comprises a first thermoplastic polymer and a second thermoplastic polymer, wherein the second polymer is soluble in a first solvent, wherein the first polymer is insoluble in the first solvent, and wherein the first polymer forms discontinuous regions in the second polymer, wherein the supporting layer comprises a supporting polymer, wherein the supporting polymer comprises a thermoplastic polymer, wherein the nanofiber layer has a first outer boundary adjacent the supporting layer, a second outer boundary on the side of the nanofiber layer opposite the supporting layer and a inner boundary located at the mid-point between the first outer boundary and the second outer boundary and parallel to the first outer boundary;
b) subjecting the nanofiber layer and the supporting layer to extensional flow and shear stress such that the first polymer forms nanofibers having an aspect ratio of at least 5:1 in the second polymer, and wherein less than about 30% by volume of the nanofibers are bonded to other nanofibers, and wherein the nanofibers are generally aligned along an axis;
c) cooling the nanofiber layer and the supporting layer to a temperature below the softening temperature of the first polymer to preserve the nanofiber shape;
d) consolidating the nanofiber layer and the supporting layer at a consolidation temperature above the T_{g} and of both the first polymer and second polymer, wherein consolidating the pre-consolidation formation is at a pressure off-axis from the nanofiber axis causing nanofiber movement, randomization, and at least 70% by volume of the nanofibers to fuse to other nanofibers, and wherein the concentration of nanofibers are substantially uniform in the nanofiber layer from the inner boundary to the first boundary layer.

13. The method of claim 12, further comprising:
e) applying the first solvent to the nano-composite article dissolving away at least a portion of the second polymer.

14. The method of claim 12, wherein the supporting polymer is soluble in the first solvent, wherein the method further comprises:
e) applying the first solvent to the nano-composite dissolving away at least a portion of the second polymer and the supporting polymer.

15. The method of claim 12, wherein the nanofiber layer further comprises nano-particles.

16. The method of claim 12, further comprising a third layer comprising an additional supporting thermoplastic polymer, wherein the third layer is located at the second outer boundary layer.

17. The method of claim 16, wherein the additional supporting thermoplastic polymer is soluble in the first solvent, wherein the method further comprises:
e) applying the first solvent to the nano-composite dissolving away at least a portion of the second, the supporting polymer, and the additional supporting polymer.

18. A nano-composite formed by the process comprising;
a) co-extruding a nanofiber layer and a supporting layer, wherein the nanofiber layer comprises a first thermoplastic polymer and a second thermoplastic polymer, wherein the second polymer is soluble in a first solvent, wherein the first polymer is insoluble in the first solvent, and wherein the first polymer forms discontinuous regions in the second polymer, wherein the supporting layer comprises a supporting polymer, wherein the supporting polymer comprises a thermoplastic polymer, wherein the nanofiber layer has a first outer boundary adjacent the supporting layer, a second outer boundary on the side of the nanofiber layer opposite the supporting layer and a inner boundary located at the mid-point between the first outer boundary and the second outer boundary and parallel to the first outer boundary;
b) subjecting the nanofiber layer and the supporting layer to extensional flow and shear stress such that the first polymer forms nanofibers having an aspect ratio of at least 5:1 in the second polymer, and wherein less than about 30% by volume of the nanofibers are bonded to other nanofibers, and wherein the nanofibers are generally aligned along an axis;
c) cooling the nanofiber layer and the supporting layer to a temperature below the softening temperature of the first polymer to preserve the nanofiber shape;
d) consolidating the nanofiber layer and the supporting layer at a consolidation temperature above the T_{g} and of both the first polymer and second polymer, wherein consolidating the pre-consolidation formation is at a pressure off-axis from the nanofiber axis causing nanofiber movement, randomization, and at least 70% by volume of the nanofibers to fuse to other nanofibers, and wherein the concentration of nanofibers are substantially uniform in the nanofiber layer from the inner boundary to the first boundary layer.

19. The nano-composite article of claim 18, further comprising a third layer comprising a supporting polymer, wherein the supporting polymer comprises a thermoplastic polymer, wherein the third layer is adjacent the second outer boundary layer and wherein the concentration of nanofibers in the nanofiber layer are substantially uniform from the first boundary layer to the second boundary layer.

20. The nano-composite article of claim 18, wherein the nanofiber layer comprises at least 2 sub-layers, wherein at least 2 of the sub-layers comprise a non-woven formed from a plurality of nanofibers, wherein at least 70% of the nanofibers are bonded to other nanofibers.

21. The nano-composite of claim 20, wherein the sub-layers of the nanofiber layer comprise different percentage by weight of nanofibers.

22. The nano-composite of claim 20, wherein the nanofibers in the sub-layers of the nanofiber layer comprise different thermoplastics.

23. The nano-composite of claim 18, wherein the nanofiber layer further comprises nano-particles.
